(19) United States
(12) Patent Application Publication
(10) Pub. No.: US 2025/0293277 A1
(43) Pub. Date: Sep. 18, 2025

(54) Apparatus for Controlling Fuel Cell and Method Thereof

(71) Applicants: Hyundai Motor Company, Seoul (KR); Kia Corporation, Seoul (KR)

(72) Inventors: Jun Su Lee, Hwaseong-Si (KR); Min Gu Park, Hwaseong-Si (KR); Ho Seung Jang, Hwaseong-Si (KR)

(21) Appl. No.: 18/964,046

(22) Filed: Nov. 29, 2024

(30) Foreign Application Priority Data
Mar. 18, 2024 (KR) 10-2024-0037285

(51) Int. Cl. H01M 8/04537; H01M 8/04746; H01M 8/2457

(52) U.S. Cl. CPC H01M 8/04611; H01M 8/04753; H01M 8/04776; H01M 8/2457

(57) ABSTRACT

An apparatus for controlling a fuel cell includes a fuel cell with an anode and a cathode, an oxygen tank that supplies oxygen to the cathode, and a processor. The processor enables the fuel cell, in response to a request to enable the fuel cell with preset electric power being less than a reference value of a stack included in the fuel cell, adjusts an internal pressure of a cathode to a preset pressure by adjusting an amount of oxygen supplied from the oxygen tank to the cathode while driving an air compressor included in the fuel cell, based on enabling of the fuel cell, and controls at least one of driving of the air compressor or a pressure of oxygen based on that the electric power being less than the reference value and more than the preset electric power while the fuel cell outputs the electric power by the preset pressure.

### CROSS-REFERENCE TO RELATED APPLICATION

This application claims the benefit of priority to Korean Patent Application No. 10-2024-0037285, filed in the Korean Intellectual Property Office on Mar. 18, 2024, the entire contents of which are incorporated herein by reference.

### TECHNICAL FIELD

The present disclosure relates to an apparatus for controlling a fuel cell and a method thereof, and more particularly, to a technology for controlling an output of a fuel cell.

### BACKGROUND

In general, a fuel cell directly converts the energy of a fuel into electrical energy, and an electrolyte may be disposed between a cathode and an anode to oxidize hydrogen in an anode and reduce oxygen in a cathode so that electricity and heat may be produced together.

Recently, as industrial fields become more diverse, the space industry and the undersea industry are also developing. Spacecraft used in the space industry and submarines used in the undersea industry may require separate components to supply oxygen because the ambient air is thin or absent.

Therefore, in situations in which current is low and voltage is high, there is a need to study ways to control electric power (or output) of a fuel cell to less than a minimum electric power that the fuel cell may output.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for controlling a fuel cell. An apparatus for controlling a fuel cell may comprise: at least one processor; and memory storing instructions that, when executed by the at least one processor, configure the apparatus to: based on receiving a request to enable the fuel cell with preset electric power less than a reference value of a stack of the fuel cell, enable the fuel cell with the preset electric power; adjust, based on the enabling of the fuel cell, an internal pressure of a cathode of the fuel cell to a preset pressure by adjusting, while driving an air compressor associated with the fuel cell, an amount of oxygen supplied from an oxygen tank to the cathode; and control, based on electric power output by the fuel cell being less than the reference value and more than the preset electric power while the internal pressure of the cathode is at the preset pressure, at least one of: driving of the air compressor; or, a pressure of oxygen in the cathode.

Also, or alternatively, a method may comprise: based on receiving a request to enable a fuel cell with preset electric power less than a reference value of a stack of the fuel cell, enabling the fuel cell with the preset electric power; adjusting, based on the enabling of the fuel cell, an internal pressure of a cathode of the fuel cell to a preset pressure by adjusting, while driving an air compressor associated with the fuel cell, an amount of oxygen supplied from an oxygen tank to the cathode; and controlling, based on electric power output by the fuel cell being less than the reference value and more than the preset electric power while the internal pressure of the cathode is at the preset pressure, at least one of: driving of the air compressor; or a pressure of oxygen in the cathode.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 illustrates an example of a block diagram related to an apparatus for controlling a fuel cell according to an example of the present disclosure;

FIG. 2 illustrates an example of a structure of a fuel cell in an example of the present disclosure;

FIG. 3 illustrates an example of a flowchart related to a method for controlling a fuel cell according to an example of the present disclosure;

FIG. 4 illustrates an example of a graph related to an operation of a fuel cell in an example of the present disclosure;

FIG. 5 illustrates an example of a graph related to an operation of a fuel cell in an example of the present disclosure;

FIG. 6 illustrates an example of a flowchart related to a method for controlling a fuel cell according to an example of the present disclosure;

FIG. 7 illustrates an example of a flowchart related to a method for controlling a fuel cell according to an example of the present disclosure; and

FIG. 8 illustrates a computing system related to an apparatus for controlling a fuel cell or a method for controlling a fuel cell according to an example of the present disclosure.

### DETAILED DESCRIPTION

Hereinafter, examples of the present disclosure will be described in detail with reference to the accompanying drawings. In adding reference numerals to the components of the drawings, it is noted that the same components are denoted by the same reference numerals even when they are drawn in different drawings. Furthermore, in describing the examples of the present disclosure, when it is determined that a detailed description of related known configurations and functions may hinder understanding of the examples of the present disclosure, a detailed description thereof will be omitted.

In describing the components of the examples of the present disclosure, terms, such as first, second, “A”, “B”, (a), and (b) may be used. The terms are simply for distinguishing the components, and the essence, the sequence, and the order of the corresponding components are not limited by the terms. Unless otherwise defined, all terms, including technical and scientific terms, used herein have the same meaning as commonly understood by those skilled in the art to which the present disclosure pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

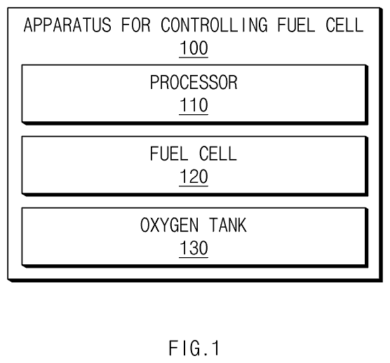

Hereinafter, examples of the present disclosure will be described in detail with reference to FIGS. 1 to 8.

FIG. 1 illustrates an example of a block diagram related to an apparatus for controlling a fuel cell according to an example of the present disclosure.

Referring to FIG. 1, an apparatus for controlling a fuel cell 100 according to an example of the present disclosure may be implemented on an inside or an outside of a mobility device (e.g., vehicle) powered by the fuel cell 100. One or more components included in the apparatus for controlling the fuel cell 100 may be implemented on the inside or the outside of the mobility device. Then, the apparatus for controlling the fuel cell 100 may be formed integrally with internal control units of the mobility device, or may be implemented as a separate device to be connected to control units of a vehicle through a separate connection means. For example, the apparatus for controlling the fuel cell 100 may further include components that are not illustrated in FIG. 1.

For example, the mobility device may include at least one of a vehicle, a submarine, or a spacecraft, or any combination thereof. The examples of the present disclosure are not limited to the above ones.

The apparatus for controlling the fuel cell 100 according to an example may include a processor 110, a fuel cell 120, and an oxygen tank 130. The processor 110, the fuel cell 120, or the oxygen tank 130 may be electronically and/or operably coupled with each other by electronic components including a communication bus.

Herein, hardware that are operatively coupled may be directly coupled or indirectly coupled to each other by wire and/or wirelessly so that, among the hardware, second hardware is controlled by first hardware.

Although illustrated in different blocks, the examples are not limited thereto. Some of the hardware in FIG. 1 may be included in a single integrated circuit including a system on a chip (SoC). The type and/or the number of hardware included in the apparatus for controlling the fuel cell 100 is not limited to that illustrated in FIG. 1. For example, the apparatus for controlling the fuel cell 100 may include only some of the hardware illustrated in FIG. 1.

The apparatus for controlling the fuel cell 100 according to an example may include hardware for processing data based on one or more instructions. The hardware for processing data may include a processor 110.

For example, the hardware for processing data may include an arithmetic and logic unit (ALU), a floating point unit (FPU), a field programmable gate array (FPGA), a central processing unit (CPU), and/or an application processor (AP). The processor 110 may include a structure of a single-core processor, or a structure of a multi-core processor including a dual core, a quad core, a hexa core, or an octa core. The processor 110 may refer to one or more processors.

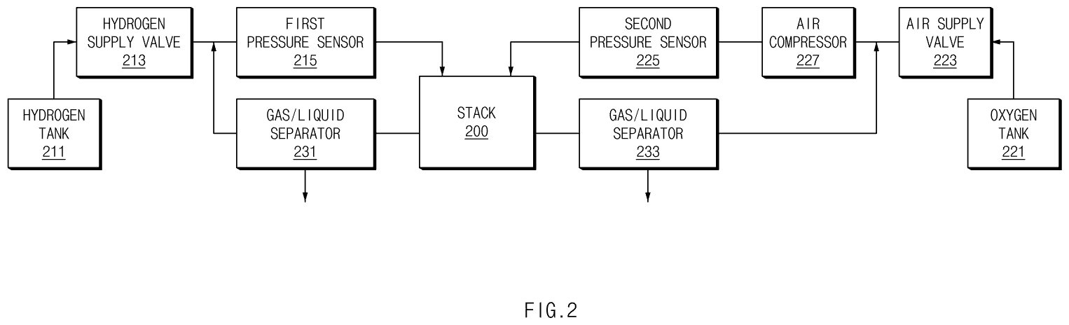

In an example, the fuel cell 120 may include an anode and a cathode. For example, hydrogen may be supplied to the anode of the fuel cell 120 to be oxidized. For example, oxygen may be supplied to the cathode of the fuel cell 120 to be reduced. For example, the fuel cell 120 may include a stack. For example, the stack of the fuel cell 120 may include components for generating electricity by reacting hydrogen and oxygen. The examples of the present disclosure are not limited to the above ones. A configuration of the fuel cell 120 will be described with respect to FIG. 2.

In an example, the apparatus for controlling the fuel cell 100 may include an oxygen tank 130. For example, the apparatus for controlling the fuel cell 100 may control an amount of oxygen that is supplied from the oxygen tank 130 to the fuel cell 120. For example, the apparatus for controlling the fuel cell 100 may control flow of oxygen from the oxygen tank 130 by adjusting valves disposed on at least a portion of a hose (and/or a pipe, passage), to which the oxygen tank 130 and the fuel cell 120 are connected. For example, the oxygen tank 130 may include components for supplying oxygen to the cathode included in the fuel cell 120. Examples of the present disclosure are not limited to the above.

In an example, the processor 110 of the apparatus for controlling the fuel cell 100 may receive a request to enable the fuel cell 120 with preset electric power that is less than a reference value of the stack included in the fuel cell 120. For example, the processor 110 may receive a request to enable the fuel cell 120 with the preset electric power (e.g., a default preset electric power and/or an electric power input by the user). For example, the reference value may include electric power for entering a mode (e.g., a low-output mode) designated by the fuel cell 120. For example, the preset electric power may be referred to as required electric power.

In an example, in response to that a request to enable the fuel cell 120 is received, the processor 110 may increase a pressure in the anode to a first target pressure by supplying hydrogen to the anode of the fuel cell 120. In response to that a request to enable the fuel cell 120 is received, the processor 110 may adjust a pressure in the cathode to a second target pressure that is less than the first target pressure by supplying at least one of oxygen or nitrogen, or any combination thereof to the cathode of the fuel cell 120. The reason that the second target pressure is less than the first target pressure may be for prevention of crossover.

In an example, the processor 110 may enable the fuel cell 120 by adjusting the pressure in the anode and the pressure in the cathode

In an example, the processor 110 may drive an air compressor included in the fuel cell 120 based on the enabling of the fuel cell 120. The processor 110 may adjust an internal pressure of the cathode to a preset pressure by adjusting the amount of the oxygen supplied to the cathode from the oxygen tank 130 while driving the air compressor included in the fuel cell 120 based on the enabling of the fuel cell 120.

In an example, while the fuel cell 120 outputs electric power by the preset pressure, the processor 110 may control the driving of the air compressor based on that the electric power is less than the reference value and more than the preset electric power.

In an example, the processor 110 may supply oxygen from the oxygen tank 130 to the cathode based on that the electric power is less than or equal to the preset electric power. The processor 110 may, based on that the electric power being less than or equal to the preset electric power, increase the electric power by supplying oxygen from the oxygen tank 130 to the cathode.

For example, the processor 110 may supply oxygen from the oxygen tank 130 to the cathode at a rate at which electric power is decreased.

In an example, while the fuel cell 120 outputs electric power, the processor 110 may decrease the amount of oxygen supplied from the oxygen tank 130 to the cathode based on the electric power being less than the reference value and more than the excess electric power obtained by applying the ratio designated by the preset electric power.

For example, the processor 110 may decrease the supply of oxygen to the cathode from the oxygen tank 130 based on a rate at which the electric power is increased.

For example, the processor 110 may, based on the electric power being less than the reference value and being identified as the excess electric power, temporarily stop driving the air compressor.

In an example, the processor 110 may enable the fuel cell 120 and drive the air compressor at a minimum RPM, which is the smallest RPM (revolutions per minute) in a range of RPM in which the air compressor is (e.g., can be, is configured to be, or set to be) operated.

In an example, the processor 110 may, based on the electric power being less than or equal to the preset electric power after a designated time has elapsed after the internal pressure of the cathode is adjusted to the preset pressure, drive the air compressor at the minimum RPM and increase the amount of oxygen supplied to the cathode from the oxygen tank 130.

In an example, the processor 110 may adjust the electric power by controlling the air compressor based on the internal pressure of the cathode reaching a designated pressure as the amount of oxygen supplied to the cathode is increased.

As described above, the apparatus for controlling the fuel cell 100 according to an example may output electric power below the reference value by adjusting the amount of oxygen supplied from the oxygen tank 130 to the fuel cell 120. The apparatus for controlling the fuel cell 100 may generate fine electric power of the fuel cell 120 by supplying oxygen to the fuel cell 120 from the oxygen tank 130 in a device, such as a submarine and/or an air craft, into which exterior air is not introduced.

FIG. 2 illustrates an example of the structure of a fuel cell in an example of the present disclosure.

Referring to FIG. 2, in an example, the fuel cell (e.g., the fuel cell 120 of FIG. 1) may include at least one of a stack 200, a hydrogen tank 211, a hydrogen supply valve 213, and a first pressure sensor 215, an oxygen tank 221, an air supply valve 223, a second pressure sensor 225, an air compressor 227, a gas/liquid separator 231, or a gas/liquid separator 233, or any combination thereof.

The apparatus for controlling a fuel cell (e.g., the apparatus for controlling the fuel cell 100 of FIG. 1) may supply hydrogen from the hydrogen tank 211 included in the fuel cell to the stack 200. For example, the apparatus for controlling a fuel cell may supply hydrogen from the hydrogen tank 211 to the anode of the stack 200.

For example, the apparatus for controlling a fuel cell may supply oxygen from the oxygen tank 221 to the stack 200. For example, the apparatus for controlling a fuel cell may supply oxygen from the oxygen tank 221 to the cathode of the stack 200.

For example, the apparatus for controlling a fuel cell may adjust an internal pressure of the cathode included in the stack 200 by adjusting the air compressor 227. Furthermore, the apparatus for controlling a fuel cell may adjust the internal pressure of the cathode by adjusting the amount of oxygen supplied from the oxygen tank 221 to the cathode included in the stack 200.

Furthermore, the apparatus for controlling a fuel cell may increase an amount of reaction of hydrogen and oxygen in the stack 200 by increasing the flow rate of oxygen supplied from the oxygen tank 221 to the stack 200 by using the air compressor 227

For example, the first pressure sensor 215 may include a sensor for identifying the internal pressure of the anode included in the stack 200. For example, the second pressure sensor 225 may include a sensor for identifying the internal pressure of the cathode included in the stack 200.

The apparatus for controlling a fuel cell according to an example may identify a concentration of hydrogen in an interior of the anode based on the first pressure sensor 215. The apparatus for controlling a fuel cell according to an example may identify the concentration of oxygen in the interior of the cathode based on the second pressure sensor 225.

For example, the gas/liquid separators 231 and 233 may separate gas and liquid that are emitted from the stack 200. For example, the apparatus for controlling a fuel cell may separate only the liquid from the gas and the liquid emitted from the stack 200 by using gas/liquid separators 231 and 233, and may discharge it to an outside.

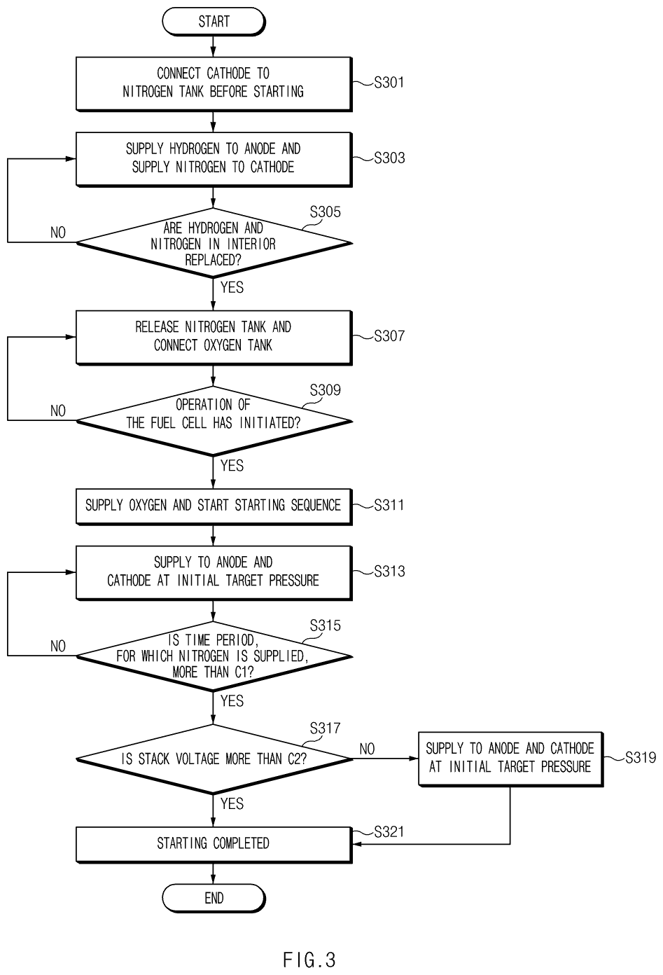

FIG. 3 illustrates an example of a flowchart related to a method for adjusting a fuel cell according to an example of the present disclosure. For convenience, FIGS. 3 and 6-7 are described by way of an example in which the steps are performed by a processor circuit. One, some, or all steps of the example methods of FIGS. 3 and 6-7, or portions thereof, may be performed by one or more other circuits. One or some, steps of the example methods of FIGS. 3 and 6-7 may be omitted, performed in other orders, and/or otherwise modified, and/or one or more additional steps may be added.

The apparatus for controlling the fuel cell 100 of FIG. 1 may be configured to perform a process of FIG. 3. Furthermore, in a description of FIG. 3, operations described as being performed by the apparatus may be understood as being controlled by the processor 110 of the apparatus for controlling the fuel cell 100.

At least one of the operations in FIG. 3 may be performed by the apparatus for controlling the fuel cell 100 of FIG. 1. At least one of the operations in FIG. 3 may be controlled by the processor 110 of FIG. 1. The operations of FIG. 3 may be performed sequentially, but is not necessarily performed sequentially. For example, the orders of the operations may be changed, and at least two operations may be performed in parallel.

Referring to FIG. 3, in operation S301, the method for controlling a fuel cell according to an example may include an operation of connecting the cathode to the nitrogen tank before starting. For example, the method for controlling a fuel cell may include an operation of connecting the cathode to the nitrogen tank before enabling the fuel cell.

In operation S303, the method for controlling a fuel cell according to an example may include an operation of supplying hydrogen to the anode and supplying nitrogen to the cathode.

For example, the method for controlling a fuel cell may include an operation of supplying hydrogen to the anode included in the stack by controlling a first gas/liquid separator and supplying nitrogen to the cathode included in the stack by controlling a second gas/liquid separator.

In operation S305, the method for controlling a fuel cell according to an example may include an operation of identifying whether the interior of the stack has been completely replaced with hydrogen and nitrogen.

If the inside of the stack is not completely replaced with hydrogen and nitrogen (No in operation S305), the method for controlling a fuel cell according to an example may include an operation of returning to operation S303, supplying hydrogen to the anode, and supplying nitrogen to the cathode.

If the interior of the stack is completely replaced with hydrogen and nitrogen (Yes in operation S305), in operation S307, the method for controlling a fuel cell according to an example may include an operation of releasing the nitrogen tank from the cathode and connecting the oxygen tank to the cathode.

In operation S309, the method for controlling a fuel cell according to an example may include an operation of identifying whether enabling of the fuel cell has been initiated. For example, the operation of identifying whether enabling of the fuel cell has been initiated may include an operation of identifying a signal that requests enabling of the fuel cell through a user input.

If enabling of the fuel cell has been initiated (No in operation S309), the oxygen tank may remain connected to the cathode and the nitrogen.

If enabling of the fuel cell has been initiated (Yes in operation S309), in operation S311, the method for controlling a fuel cell according to an example may include an operation of supplying oxygen to the cathode and starting a starting sequence.

For example, the method for controlling a fuel cell may include an operation of supplying oxygen from the oxygen tank to the cathode.

In operation S313, the method for controlling a fuel cell according to an example may include an operation of supplying hydrogen and oxygen to the anode and the cathode at initial target pressures.

For example, the initial target pressure of the anode may be more than the initial target pressure of the cathode. For example, the initial target pressure of the anode may include approximately 150 kPa. For example, the initial target pressure of the cathode may include approximately 95 kPa.

In operation S315, the method for controlling a fuel cell according to an example may include an operation of identifying whether a time period for supplying nitrogen to the cathode is more than C1.

For example, C1 may be a crossover time. For example, C1 may be approximately 10 minutes.

If the time period for supplying nitrogen is not more than C1 (No in operation S315), the method for controlling a fuel cell according to an example an operation of returning to operation S313 and supplying hydrogen and oxygen to the anode and the cathode at the initial target pressures.

If the time period for supplying nitrogen is more than C1 (Yes in operation S315), in operation S317, the method for controlling a fuel cell according to an example may include an operation of identifying whether the stack voltage is more than C2.

For example, the stack voltage may include the electric power of the fuel cell. For example, the method for controlling a fuel cell may include an operation of identifying whether oxygen is smoothly supplied and whether the concentration of oxygen in the cathode is sufficient, based on the stack voltage.

If the stack voltage is not more than C2 (No in operation S317), in operation S319, the method for controlling a fuel cell according to an example may include an operation of supplying hydrogen and oxygen to the anode and the cathode at the initial target pressure.

For example, operation S319 may be substantially the same as operation 313.

If the stack voltage is more than C2 (Yes in operation S317), in operation S321, the method for controlling a fuel cell according to an example may include an operation of identifying whether the enabling of the fuel cell is completed.

For example, completion of enabling of the fuel cell may mean that the fuel cell has been enabled for use (e.g., for powering a vehicle).

As described above, the apparatus for controlling a fuel cell according to an example may control the starting of the fuel cell by supplying gas to the anode and the cathode included in the fuel cell.

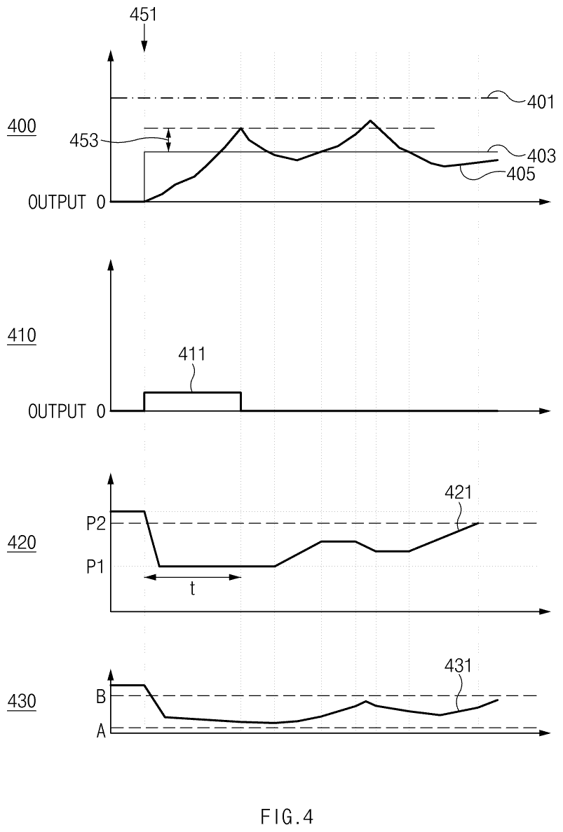

FIG. 4 illustrates an example of a graph related to an operation of a fuel cell in an example of the present disclosure.

Referring to FIG. 4, the processor (e.g., the processor 110 of FIG. 1) of the apparatus for controlling a fuel cell (e.g., the apparatus for controlling the fuel cell 100 of FIG. 1) according to an example may receive a request to enable the fuel cell (e.g., the fuel cell 120 of FIG. 1) with a preset electric power 403 that is less than a reference value 401.

For example, the first graph 400 is related to the electric power of the fuel cell. For example, in the first graph 400, the reference value 401 may include a minimum output that the fuel cell may generate based on the air compressor and the supply of oxygen. For example, in the first graph 400, the preset electric power 403 may be input by the user. For example, in the first graph 400, the electric power 405 may be determined based on at least one of the driving of the air compressor, the internal pressure of the cathode, or the concentration of oxygen in the interior of the cathode, or any combination thereof.

For example, the second graph 410 is related to an RPM of an air compressor. For example, in the second graph 410, the driving RPM 411 may indicate that the air compressor is operated at a designated RPM.

For example, the third graph 420 shows an internal pressure 421 of the cathode included in the fuel cell. For example, in the third graph 420, an internal pressure 421 may be determined by the amount of oxygen supplied from the oxygen tank to the cathode of the stack.

For example, the fourth graph 430 shows the oxygen concentration 431 in the interior of the cathode included in the fuel cell.

For example, the processor of the apparatus for controlling a fuel cell may perform a control such that electric power 405 may be output from the stack of the fuel cell based on at least one of the driving RPM 411, the internal pressure 421, or the oxygen concentration 431, or any combination thereof.

Referring to FIG. 4, the apparatus for controlling a fuel cell may identify whether the fuel cell enters a low-output section at a first time point 451. If the fuel cell enters the low-output section, the apparatus for controlling a fuel cell may drive the driving RPM 411 of the air compressor at a minimum RPM that is the smallest RPM in an RPM range, in which the air compressor may be operated. Furthermore, the apparatus for controlling a fuel cell may determine the internal pressure 421 of the cathode as P1.

The apparatus for controlling a fuel cell according to an example may stop the operation of the air compressor based on that the electric power 405 is more than or equal to the preset electric power 403 and less than the reference value 401 after time “t” has elapsed from the first time point 451.

For example, the apparatus for controlling a fuel cell may stop the driving of the air compressor based on the electric power 405 is more than or equal to the excess electric power, in which the specific electric power 453 is added to the preset electric power 403.

The apparatus for controlling a fuel cell may increase the internal pressure 421 and the oxygen concentration 431 of the cathode if the electric power 405 is decreased below the preset electric power 403 over time.

The apparatus for controlling a fuel cell may increase electric power 405 by increasing the internal pressure 421 and the oxygen concentration 431 of the cathode.

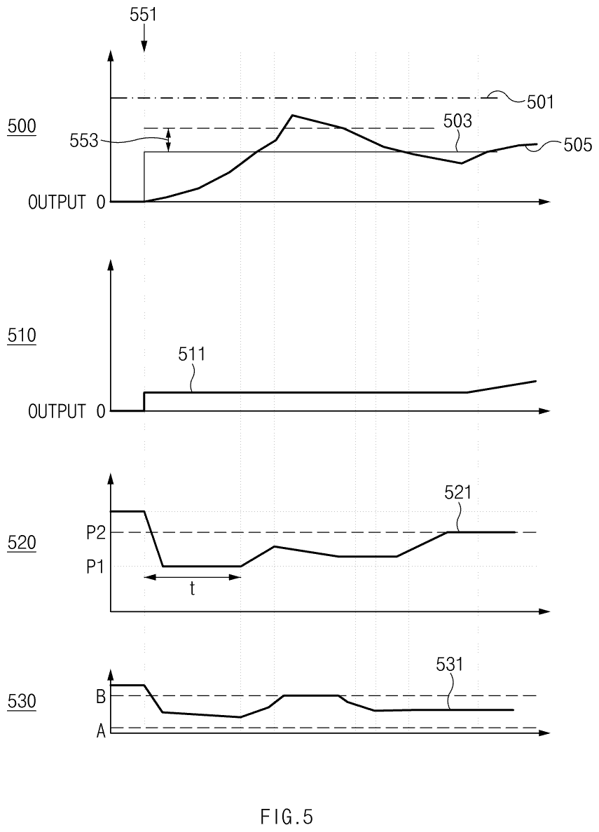

As described above, the apparatus for controlling a fuel cell according to an example may increase an energy efficiency by adjusting the internal pressure 421 and the oxygen concentration 431 of the cathode in a state, in which the driving of the air compressor is stopped (driving RPM 411 is 0) by adjusting the electric power 405 that is generated in the stack of the fuel cell. FIG. 5 illustrates an example of a graph related to an operation of the fuel cell in an example of the present disclosure.

Referring to FIG. 5, the processor (e.g., the processor 110 of FIG. 1) of the apparatus for controlling a fuel cell (e.g., the apparatus for controlling the fuel cell 100 of FIG. 1) according to an example may receive a request to enable the fuel cell (e.g., fuel cell 120 of FIG. 1) to preset electric power 503 that is less than a reference value 501.

For example, a first graph 500 is related to the electric power of the fuel cell. For example, in the first graph 500, the reference value 501 may include a minimum output that the fuel cell may generate based on the air compressor and the supply of oxygen. For example, in the first graph 500, preset electric power 503 may include electric power that is input by the user. For example, in the first graph 500, the electric power 505 may be determined based on at least one of the driving of the air compressor, the internal pressure of the cathode, or the oxygen concentration in the interior of the cathode, or any combination thereof.

For example, a second graph 510 is related to the RPM of the air compressor. For example, in the second graph 510, the driving RPM 511 may indicate that the air compressor is operated at a specific RPM.

For example, the third graph 520 shows an internal pressure 521 of the cathode included in the fuel cell. For example, in the third graph 520, the internal pressure 521 may be determined by the amount of oxygen that is supplied from the oxygen tank to the cathode of the stack.

For example, a fourth graph 530 shows a concentration 531 of oxygen in the interior of the cathode included in the fuel cell.

Referring to FIG. 5, the apparatus for controlling a fuel cell may identify whether the fuel cell enters the low-output section at a first time point 551. The fuel cell that has entered the low-output section may mean that the preset electric power 503 has been set below the reference value 501. If the fuel cell enters the low-output section, the apparatus for controlling a fuel cell may drive the driving RPM 511 of the air compressor at the minimum RPM that is the smallest RPM in an RPM range in which the air compressor may be operated. Furthermore, the apparatus for controlling a fuel cell may determine an internal pressure 521 of the cathode as P1.

If the electric power 505 is less than or equal to the preset electric power 503 after time “t” has elapsed from the first point in time 551, the apparatus for controlling a fuel cell according to an example may drive (e.g., continue to drive) the driving RPM 511 of the air compressor at the minimum RPM, increase the internal pressure 521 of the cathode, and/or increase the concentration 531 of oxygen.

For example, the apparatus for controlling a fuel cell may maintain the internal pressure 521 of the cathode if the electric power 505 reaches the preset electric power 503 so that the electric power 505 is output at the preset electric power 503 or higher.

For example, if the electric power 505 is more than the excess electric power, in which specific electric power 553 is added to the preset electric power 503, the apparatus for controlling a fuel cell may adjust the electric power 505 to the excess electric power or less by decreasing the internal pressure 521 of the cathode.

For example, the apparatus for controlling a fuel cell may maintain the internal pressure 521 of the cathode in a current state if the electric power 505 is less than or equal to the excess electric power.

For example, the apparatus for controlling a fuel cell may perform a control such that the electric power 505 satisfies the preset electric power 503 by controlling the air compressor if the internal pressure 521 of the cathode reaches P2.

If the driving RPM 511 of the air compressor is maintained for more than a designated time period or more in a state in which the electric power 505 is more than the excess electric power while driven by a minimum RPM, the apparatus for controlling a fuel cell may re-enter the low-output section.

As described above, the apparatus for controlling a fuel cell according to an example may increase the energy efficiency by minimizing the driving of the air compressor to adjust the electric power 505 of the fuel cell.

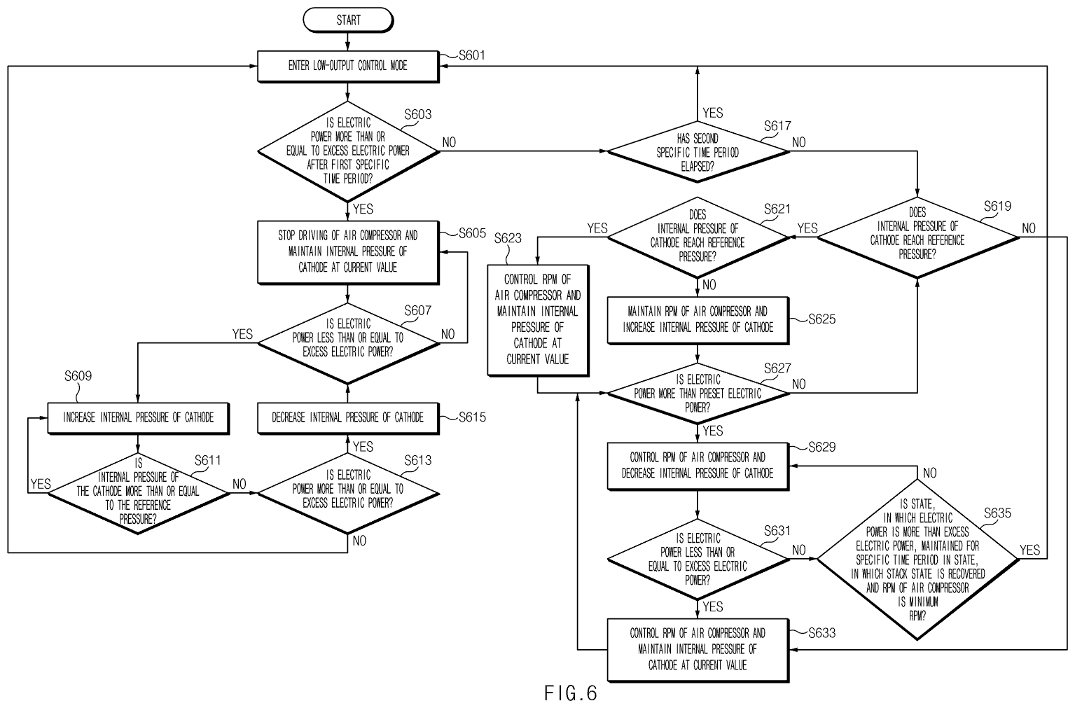

FIG. 6 illustrates an example of a flowchart that is related to the method for controlling a fuel cell according to an example of the present disclosure.

Hereinafter, it is assumed that the apparatus for controlling the fuel cell 100 of FIG. 1 performs a process of FIG. 6. Furthermore, in a description of FIG. 6, operations described as being performed by the device may be understood as being controlled by the processor 110 of the apparatus for controlling the fuel cell 100.

At least one of the operations in FIG. 6 may be performed by the apparatus for controlling the fuel cell 100 in FIG. 1. At least one of the operations of FIG. 6 may be controlled by the processor 110 in FIG. 1. The operations of FIG. 6 may be performed sequentially, but is not necessarily performed sequentially. For example, the orders of the operation may be changed, and at least two operations may be performed in parallel.

Referring to FIG. 6, in operation S601, the method for controlling a fuel cell according to an example may include an operation of entering a low output control mode. For example, the method for controlling a fuel cell may include an operation of setting a mode for controlling the fuel transfer to a low-output control mode based on that the fuel cell has entered the low-output section.

In operation S603, the method for controlling a fuel cell according to an example may include an operation of identifying whether the electric power of the fuel cell is more than or equal to the excess electric power after a first specific time period.

If the electric power of the fuel cell is more than or equal to the excess electric power (Yes in operation S603) after the first specific time period, in operation S605, the method for controlling a fuel cell according to an example may include an operation of stopping the driving the air compressor, and maintaining the internal pressure of the cathode at a current value.

In operation S607, the method for controlling a fuel cell according to an example may include an operation of identifying whether the electric power of the fuel cell is less than or equal to the preset electric power.

If the electric power of the fuel cell is less than or equal to the preset electric power (Yes in operation S607), in operation S609, the method for controlling a fuel cell according to an example may include an operation of increasing the internal pressure of the cathode.

If the internal pressure of the cathode is not the reference pressure or more (No in operation S611), in operation S611, the method for controlling a fuel cell according to an example includes an operation to identify whether the internal pressure of the cathode is more than or equal to the reference pressure.

If the internal pressure of the cathode is more than or equal to the reference pressure (Yes in operation S611), the method for controlling a fuel cell according to an example may include an operation of returning to operation S609 and increasing the internal pressure of the cathode.

In operation S613, the method for controlling a fuel cell according to an example may include an operation of identifying whether the electric power of the fuel cell is more than or equal to the excess electric power.

If the electric power of the fuel cell is more than or equal to the excess electric power (Yes in operation S613), in operation S615, the method for controlling a fuel cell according to an example may include an operation of decreasing the internal pressure of the cathode.

If the electric power of the fuel cell is not the excess electric power or more (No in operation S613), the method for controlling a fuel cell according to an example may include an operation of returning to operation S609 and increasing the internal pressure of the cathode.

If the electric power of the fuel cell is not the excess electric power or more after the first specific time period (No in operation S603), in operation S617, the method for controlling a fuel cell according to an example may include identifying whether the second specific time period has elapsed.

If the second specific time period has not elapsed (No in operation S617), the method for controlling a fuel cell according to an example may include an operation of returning to operation S601 and entering the low output control mode.

If the second specific time period has elapsed (Yes in operation S617), in operation S619, the method for controlling a fuel cell according to an example may include an operation of identifying whether the electric power of the fuel cell is less than or equal to the preset electric power.

If the electric power of the fuel cell is less than or equal to the preset electric power (Yes in operation S619), in operation S621, the method for controlling a fuel cell according to an example may include an operation of identifying whether the internal pressure of the cathode has reached the reference pressure.

If the internal pressure of the cathode reaches the reference pressure (Yes in operation S621), in operation S623, the method for controlling a fuel cell according to an example may include an operation of controlling the RPM of the air compressor and maintaining the internal pressure of the cathode at a current value.

If the internal pressure of the cathode does not reach the reference pressure (No in operation S621), in operation S625, the method for controlling a fuel cell according to an example may include an operation of maintaining the RPM of the air compressor and increasing the internal pressure of the cathode.

In operation S627, the method for controlling a fuel cell according to an example may include an operation of identifying whether the electric power of the fuel cell is more than the preset electric power.

If the electric power of the fuel cell is not more than the preset electric power (No in operation S627), the method for controlling a fuel cell according to an example may include an operation of identifying whether the electric power of the fuel cell is less than or equal to the preset electric power in operation S619.

If the electric power of the fuel cell is more than the preset electric power (Yes in operation S627), in operation S629, the method for controlling a fuel cell according to an example may include an operation of controlling the RPM of the air compressor and decreasing the internal pressure of the cathode.

In operation S631, the method for controlling a fuel cell according to an example may include an operation of identifying whether the electric power of the fuel cell is less than or equal to the excess electric power. For example, the excess electric power may include electric power greater than the preset electric power by a designated ratio applied to the preset electric power. The designated ratio may be obtained by experiment. The designated ratio may be a positive number.

If the electric power of the fuel cell is less than or equal to the excess electric power (Yes in operation S631), in operation S633, the method for controlling a fuel cell according to an example may include an operation of controlling the RPM of the air compressor and maintaining the internal pressure of the cathode at a current value.

If the electric power of the fuel cell is not the excess electric power or less (No of operation S631), in operation S635, the method for controlling a fuel cell according to an example may include an operation of identifying the electric power is maintained for a specific time period in a state, in which it is more than the excess electric power, in a state, in which the stack state is recovered and the air compressor is at the minimum RPM.

If the electric power is not maintained at more than the excess electric power for a specific time period in a state, in which the stack state is recovered and the air compressor is at the minimum RPM (No of operation S635), the method for controlling a fuel cell according to an example may include an operation of returning to operation S629, controlling the RPM of the air compressor, and decreasing the internal pressure of the cathode.

If the electric power is maintained at more than the excess electric power for a specific time period in a state, in which the stack state is recovered and the air compressor is at the minimum RPM (Yes of operation S635), the method for controlling a fuel cell according to an example may include an operation of returning to operation S601, and entering the low-output control mode.

As described above, the method for controlling a fuel cell according to an example includes an operation of adjusting the electric power of the fuel cell by adjusting at least one of the air compressor or oxygen, or any combination thereof, depending on the electric power. In particular, the method for controlling a fuel cell may supply the electric power by using the fuel cell in various environments by controlling the output of the fuel cell by supplying oxygen from the oxygen tank in a state, in which there is not enough air in the surrounding space including the fuel cell.

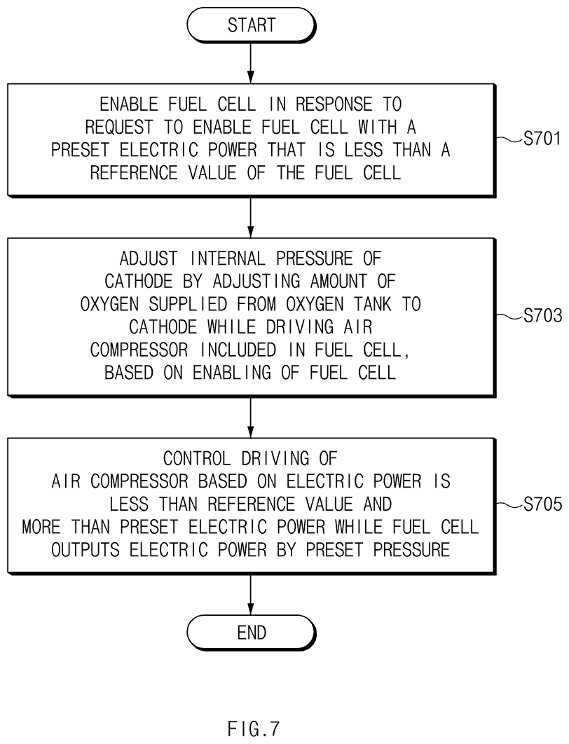

FIG. 7 illustrates an example of a flowchart that is related to the method for controlling a fuel cell according to an example of the present disclosure.

Hereinafter, it is assumed that the apparatus for controlling the fuel cell 100 of FIG. 1 performs a process of FIG. 7. Furthermore, in a description of FIG. 7, operations described as being performed by the device may be understood as being controlled by the processor 110 of the apparatus for controlling the fuel cell 100.

At least one of the operations in FIG. 7 may be performed by the apparatus for controlling the fuel cell 100 in FIG. 1. At least one of the operations in FIG. 7 may be controlled by the processor 110 in FIG. 1. The operations in FIG. 7 may be performed sequentially, but is not necessarily performed sequentially. For example, the orders of the operations may be changed, and at least two operations may be performed in parallel.

Referring to FIG. 7, in operation S701, the method for controlling a fuel cell according to an example may include an operation of enabling the fuel cell in response to a request to enable the fuel cell with a preset electric power that is less than the reference value of the stack included in the fuel cell.

For example, the method for controlling a fuel cell may include an operation of adjusting the pressure in the anode to a first target pressure by supplying hydrogen to the anode included in the fuel cell, in response to that the request is received. For example, the method for controlling a fuel cell may include an operation of adjusting the pressure in the cathode to a second target pressure that is less than the first target pressure by supplying at least one of oxygen or nitrogen, or any combination thereof to the cathode included in the fuel cell, in response to the request being received.

For example, the method for controlling a fuel cell may include an operation of enabling the fuel cell by adjusting the pressure in the anode and/or the pressure in the cathode.

In operation S703, the method for controlling a fuel cell according to an example may include an operation of, based on the enabling of the fuel cell, adjusting the internal pressure of the cathode to the preset pressure by adjusting the amount of the oxygen supplied from the oxygen tank to the cathode while driving the air compressor included in the fuel cell.

In operation S705, the method for controlling a fuel cell according to an example may include an operation of controlling driving of the air compressor based on the electric power output by the fuel cell being less than the reference value and more than the preset electric power while the fuel cell outputs the electric power by the preset electric power.

For example, the method for controlling a fuel cell may include an operation of controlling at least one of driving of the air compressor and the pressure of oxygen based on that the electric power is less than the reference value and more than the preset electric power while the fuel cell outputs the electric power by the preset pressure.

According to the example, the method for controlling a fuel cell may include an operation of controlling at least one of driving of the air compressor, or the pressure of oxygen, or any combination thereof based on that the electric power is less than the reference value and more than the preset electric power while the fuel cell outputs the electric power by preset pressure.

For example, the method for controlling a fuel cell may include an operation of controlling driving of the air compressor or adjusting the amount of oxygen supplied from the oxygen tank to the cathode based on that the electric power is less the reference value and more than the preset electric power while the fuel cell outputs the electric power by the preset pressure.

For example, the method for controlling a fuel cell may include an operation of increasing the electric power by supplying oxygen from the oxygen tank to the cathode, based on that the electric power is less than or equal to the preset electric power.

For example, the method for controlling a fuel cell may include an operation of supplying oxygen based on that a rate, at which the electric power is decreased when oxygen is supplied from the oxygen tank to the cathode.

For example, the method for controlling a fuel cell may include an operation of decreasing the amount of oxygen supplied from the oxygen tank to the cathode based on that the electric power is less than the reference value and more than the excess electric power, in which the ratio designated by the preset electric power is applied, while the fuel cell outputs the electric power.

For example, the method for controlling a fuel cell may include an operation of decreasing the supply of oxygen based on a rate, at which the electric power is increased when the oxygen supplied from the oxygen tank to the cathode is decreased.

For example, the method for controlling a fuel cell may include an operation of temporarily stopping the operation of the air compressor, based on that it is identified that the electric power is less than the reference value and more than the excess electric power.

For example, the method for controlling a fuel cell may include an operation of driving the air compressor at a minimum RPM that is the smallest RPM in the RPM range, in which the air compressor may be operated.

For example, the method for controlling a fuel cell an operation of increasing the amount of oxygen supplied from the oxygen tank to the cathode while driving the air compressor at the minimum RPM, based on that the electric power is less than or equal to the preset electric power after a designated time period has elapsed after adjusting the internal pressure of the cathode to the For example, the method for controlling a fuel cell may include an operation of adjusting the electric power by controlling the air compressor based on that the internal pressure of the cathode reaches a designated pressure by increasing or decreasing the amount of oxygen supplied to the cathode.

As described above, the method for controlling a fuel cell according to an example may cause the fuel cell to generate electric power that is less than the reference value of the fuel cell by adjusting oxygen supplied to the cathode. Furthermore, the fuel cell may generate electric power in various environments by generating the electric power from the fuel cell by using the oxygen tank in a state, in which it is difficult to supply air because there is no air around the fuel cell.

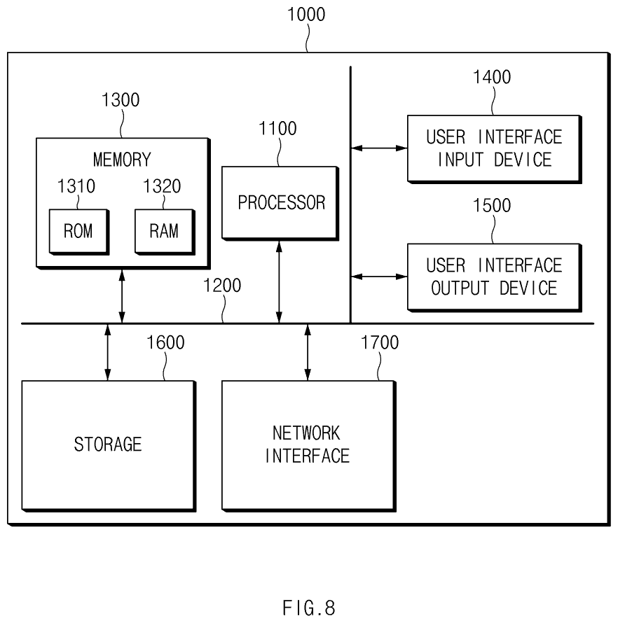

FIG. 8 illustrates a computing system/device related to the apparatus for controlling a fuel cell or the method for controlling a fuel cell according to an example of the present disclosure.

Referring to FIG. 8, a computing system 1000 may include at least one processor 1100 (e.g., processor 110), a memory 1300, a user interface input device 1400, a user interface output device 1500, a storage 1600, and a network interface 1700, which are connected through a bus 1200.

The at least one processor 1100 may be a central processing unit (CPU), or a semiconductor device that processes instructions stored in the memory 1300 and/or the storage 1600. The memory 1300 and/or the storage 1600 may include various volatile or nonvolatile storage media, including non-transitory computer readable media storing the instructions. For example, the memory 1300 may include a read only memory (ROM) 1310 and a random access memory (RAM) 1320.

Accordingly, the steps of the method or algorithm described in relation to the examples of the present disclosure may be implemented by hardware and/or software executed by the at least one processor 1100. The software (e.g., the instructions) may reside in the non-transitory computer-readable storage medium (that is, the memory 1300 and/or the storage 1600), such as a RAM, a flash memory, a ROM, an EPROM, an EEPROM, a register, a hard disk, a solid state drive (SSD), a detachable disk, or a CD-ROM.

The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor and the storage medium may reside in the user terminal as an individual component.

The present disclosure has been made to solve the above-mentioned problems occurring in the prior art while advantages achieved by the prior art are maintained intact.

Examples of the present disclosure relate to an disclosure related to an apparatus for controlling a fuel cell including an oxygen tank, and provide an apparatus for controlling a fuel cell, by which electric power of a fuel cell is generated by using an oxygen tank in a state, in which there is not enough air around the fuel cell, and a method thereof.

Examples of the present disclosure provide an apparatus for controlling a fuel cell, and a method thereof, by which fine electric power is generated by controlling electric power of the fuel cell by adjusting an amount of oxygen supplied to a cathode included in the fuel cell.

Examples of the present disclosure provide an apparatus for controlling a fuel cell and a method thereof, by which an energy efficiency is increased by controlling electric power of the fuel cell, by adjusting an amount of oxygen supplied to a cathode included in the fuel cell.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for controlling a fuel cell, the apparatus includes a fuel cell including an anode and a cathode, an oxygen tank that supplies oxygen to the cathode, and a processor, and the processor enables the fuel cell in response to that a request to enable the fuel cell with preset electric power being less than a reference value of a stack included in the fuel cell is received, adjusts an internal pressure of a cathode to a preset pressure by adjusting an amount of oxygen supplied from the oxygen tank to the cathode while driving an air compressor included in the fuel cell, based on enabling of the fuel cell, and controls at least one of driving of the air compressor and a pressure of oxygen based on that the electric power is less than the reference value and more than the preset electric power while the fuel cell outputs the electric power by the preset pressure.

In an example, the processor may in response to that the request is received, adjust a pressure in the anode to a first target pressure by supplying hydrogen to the anode, adjust a pressure in the cathode to a second target pressure being less than the first target pressure by supplying at least one of oxygen or nitrogen, or any combination thereof to the cathode, and enable the fuel cell by adjusting the pressure in the anode and the pressure in the cathode.

In an example, the processor may increase the electric power by supplying oxygen from the oxygen tank to the cathode based on that the electric power is less than or equal to the preset electric power.

In an example, the processor may supply oxygen based on a rate, at which the electric power is decreased, when oxygen is supplied from the oxygen tank to the cathode.

In an example, the processor may decrease the amount of oxygen supplied from the oxygen tank to the cathode based on that the electric power is less than the reference value and more than excess electric power obtained by applying a specific ratio to the preset electric power while the fuel cell outputs the electric power.

In an example, the processor may decrease supply of oxygen based on a rate, at which the electric power is increased, when the amount of oxygen supplied from the oxygen tank to the cathode is decreased.

In an example, the processor may temporarily stop driving of the air compressor based on that the electric power is more than the preset electric power.

In an example, the processor may drive the air compressor at a minimum RPM (revolutions per minute) being a lowest RPM in a range of RPMs, by which the air compressor is operated.

In an example, the processor may increase the amount of oxygen supplied from the oxygen tank to the cathode while the air compressor is driven at the minimum RPM, based on that the electric power is less than the preset electric power after a specific time period after the internal pressure of the cathode is adjusted to the preset pressure.

In an example, the processor may adjust the electric power by controlling the air compressor, based on the internal pressure of the cathode reaches a specific pressure as the amount of oxygen supplied to the cathode is increased.

According to another aspect of the present disclosure, a method for controlling a fuel cell includes enabling, by a processor, the fuel cell in response to that a request to enable the fuel cell with preset electric power being less than a reference value of a stack included in the fuel cell is received, adjusting an internal pressure of a cathode to a preset pressure by adjusting an amount of oxygen supplied from the oxygen tank to the cathode while driving an air compressor included in the fuel cell, based on enabling of the fuel cell, and controlling at least one of driving of the air compressor and a pressure of oxygen based on that the electric power is less than the reference value and more than the preset electric power while the fuel cell outputs the electric power by the preset pressure.

In an example, the method for controlling a fuel cell may include in response to that the request is received, adjusting a pressure in an anode to a first target pressure by supplying hydrogen to the anode included in the fuel cell, adjusting a pressure in the cathode to a second target pressure being less than the first target pressure by supplying at least one of oxygen or nitrogen, or any combination thereof to the cathode, and enabling the fuel cell by adjusting the pressure in the anode and the pressure in the cathode.

In an example, the method for controlling a fuel cell may include increasing the electric power by supplying oxygen from the oxygen tank to the cathode based on that the electric power is less than or equal to the preset electric power.

In an example, the method for controlling a fuel cell may include supplying oxygen based on a rate, at which the electric power is decreased, when oxygen is supplied from the oxygen tank to the cathode.

In an example, the method for controlling a fuel cell may include decreasing the amount of oxygen supplied from the oxygen tank to the cathode based on that the electric power is less than the reference value and more than excess electric power obtained by applying a specific ratio to the preset electric power while the fuel cell outputs the electric power.

In an example, the method for controlling a fuel cell may include decreasing supply of oxygen based on a rate, at which the electric power is increased, when the amount of oxygen supplied from the oxygen tank to the cathode is decreased.

In an example, the method for controlling a fuel cell may include temporarily stopping driving of the air compressor based on that the electric power is more than the preset electric power.

In an example, the method for controlling a fuel cell may include driving the air compressor at a minimum RPM (revolutions per minute) being a lowest RPM in a range of RPMs, by which the air compressor is operated.

In an example, the method for controlling a fuel cell may include increasing the amount of oxygen supplied from the oxygen tank to the cathode while the air compressor is driven at the minimum RPM, based on that the electric power is less than the preset electric power after a specific time period after the internal pressure of the cathode is adjusted to the preset pressure.

In an example, the method for controlling a fuel cell may include adjusting the electric power by controlling the air compressor, based on the internal pressure of the cathode reaches a specific pressure as the amount of oxygen supplied to the cathode is increased.

The present technology is an disclosure related to the apparatus for controlling a fuel cell including the oxygen tank, and electric power of the fuel cell may be generated by using the oxygen tank in a state, in which there is not enough air around the fuel cell.

Furthermore, according to the present technology, fine electric power may be generated by controlling electric power of the fuel cell by adjusting the amount of oxygen supplied to the cathode included in the fuel cell.

Also, or alternatively, the present technology may increase an energy efficiency by controlling the electric power of the fuel cell, by adjusting the amount of oxygen supplied to the cathode included in the fuel cell.

Also, or alternatively, various effects that may be directly or indirectly identified through this document may be provided.

The above description is a simple exemplary description of the technical spirits of the present disclosure, and an ordinary person in the art, to which the present disclosure pertains, may make various corrections and modifications without departing from the essential characteristics of the present disclosure.

Therefore, the examples disclosed in the present disclosure are not for limiting the technical spirits of the present disclosure but for describing them, and the scope of the technical spirits of the present disclosure is not limited by the examples. The protection scope of the present disclosure should be construed by the following claims, and all the technical spirits in the equivalent range should be construed as being included in the scope of the present disclosure.

What is claimed is:

1. An apparatus for controlling a fuel cell, the apparatus comprising:
at least one processor; and
memory storing instructions that, when executed by the at least one processor, configure the apparatus to:
based on receiving a request to enable the fuel cell with preset electric power less than a reference value of a stack of the fuel cell, enable the fuel cell with the preset electric power;
adjust, based on the enabling of the fuel cell, an internal pressure of a cathode of the fuel cell to a preset pressure by adjusting, while driving an air compressor associated with the fuel cell, an amount of oxygen supplied from an oxygen tank to the cathode; and
control, based on electric power output by the fuel cell being less than the reference value and more than the preset electric power while the internal pressure of the cathode is at the preset pressure, at least one of:
driving of the air compressor; or,
a pressure of oxygen in the cathode.

2. The apparatus of claim 1, wherein the instructions, when executed by the at least one processor, further configure the apparatus to:
based on the request being received:
adjust a pressure in an anode to a first target pressure by supplying hydrogen to the anode;
adjust the pressure in the cathode to a second target pressure, less than the first target pressure, by supplying at least one of oxygen or nitrogen, or any combination thereof, to the cathode; and
enable the fuel cell further based on the adjusting the pressure in the anode and the pressure in the cathode.

3. The apparatus of claim 1, wherein the instructions, when executed by the at least one processor, configure the apparatus to:
based on the electric power being less than or equal to the preset electric power, increase the electric power by supplying oxygen from the oxygen tank to the cathode.

4. The apparatus of claim 3, wherein the instructions, when executed by the at least one processor, configure the apparatus to:
supply the oxygen based on a rate at which the electric power is decreased, when oxygen is supplied from the oxygen tank to the cathode.

5. The apparatus of claim 1, wherein the instructions, when executed by the at least one processor, configure the apparatus to:
decrease the amount of oxygen supplied from the oxygen tank to the cathode based on the electric power being less than the reference value and more than an excess electric power greater than the preset electric power.

6. The apparatus of claim 5, wherein the instructions, when executed by the at least one processor, configure the apparatus to:
decrease the amount of oxygen supplied from the oxygen tank by decreasing a rate at which the oxygen is supplied to a rate configured to cause the electric power to increase.

7. The apparatus of claim 1, wherein the instructions, when executed by the at least one processor, configure the apparatus to:
based on the electric power being more than the preset electric power, temporarily stop driving of the air compressor.

8. The apparatus of claim 1, wherein the instructions, when executed by the at least one processor, configure the apparatus to:
drive the air compressor at a minimum revolutions per minute (RPM), wherein the minimum RPM is a lowest RPM in a range of RPMs at which the air compressor is configured to operate.

9. The apparatus of claim 8, wherein the instructions, when executed by the at least one processor, configure the apparatus to:
while the air compressor is driven at the minimum RPM, increase the amount of oxygen supplied from the oxygen tank to the cathode based on the electric power being less than the preset electric power after a specific time period after the internal pressure of the cathode is adjusted to the preset pressure.

10. The apparatus of claim 9, wherein the instructions, when executed by the at least one processor, configure the apparatus to:
based on the internal pressure of the cathode reaching a specific pressure as the amount of oxygen supplied to the cathode is increased, adjust the electric power by controlling the air compressor.

11. A method comprising:
based on receiving a request to enable a fuel cell with preset electric power less than a reference value of a stack of the fuel cell, enabling the fuel cell with the preset electric power;
adjusting, based on the enabling of the fuel cell, an internal pressure of a cathode of the fuel cell to a preset pressure by adjusting, while driving an air compressor associated with the fuel cell, an amount of oxygen supplied from an oxygen tank to the cathode; and
controlling, based on electric power output by the fuel cell being less than the reference value and more than the preset electric power while the internal pressure of the cathode is at the preset pressure, at least one of:
driving of the air compressor; or
a pressure of oxygen in the cathode.

12. The method of claim 11 further comprising:
based on the request being received:
adjusting a pressure in an anode of the fuel cell to a first target pressure by supplying hydrogen to the anode;
adjusting the pressure in the cathode to a second target pressure less than the first target pressure by supplying at least one of oxygen or nitrogen, or any combination thereof, to the cathode; and
wherein the enabling the fuel cell is further based on the adjusting the pressure in the anode and the pressure in the cathode.

13. The method of claim 11 further comprising:
based on the electric power being less than or equal to the preset electric power, increasing the electric power by supplying oxygen from the oxygen tank to the cathode.

14. The method of claim 13, wherein the supplying the oxygen based on a rate at which the electric power is decreased, when oxygen is supplied from the oxygen tank to the cathode.

15. The method of claim 11 further comprising:
decreasing the amount of oxygen supplied from the oxygen tank to the cathode based on the electric power being less than the reference value and more than an excess electric power greater than the preset electric power.

16. The method of claim 15 further comprising:
decreasing the amount of oxygen supplied from the oxygen tank by decreasing a rate at which the oxygen is supplied to a rate configured to cause the electric power to increase.

17. The method of claim 11 further comprising:
based on the electric power being more than the preset electric power, temporarily stopping driving of the air compressor.

18. The method of claim 11 further comprising:
driving the air compressor at a minimum revolutions per minute (RPM), wherein the minimum RPM is a lowest RPM in a range of RPMs at which the air compressor is configured to operate.

19. The method of claim 18 further comprising:
while the air compressor is driven at the minimum RPM, increasing the amount of oxygen supplied from the oxygen tank to the cathode based on the electric power being less than the preset electric power after a specific time period after the internal pressure of the cathode is adjusted to the

20. The method of claim 19 further comprising:
based on the internal pressure of the cathode reaching a specific pressure as the amount of oxygen supplied to the cathode is increased, adjusting the electric power by controlling the air compressor.
